(19) United States
(12) Patent Application Publication
(10) Pub. No.: US 2014/0218296 A1
(43) Pub. Date: Aug. 7, 2014

(54) OPTICAL NAVIGATION SYSTEM AND OPTICAL NAVIGATION APPARATUS THEREOF

(71) Applicant: PIXART IMAGING INC., HSIN-CHU (TW)

(72) Inventors: Ching-Lin CHUNG, HSIN-CHU (TW); Yen-Min CHANG, HSIN-CHU (TW)

(73) Assignee: PIXART IMAGING INC., HSIN-CHU (TW)

(21) Appl. No.: 13/965,896

(22) Filed: Aug. 13, 2013

(30) Foreign Application Priority Data
Feb. 6, 2013 (TW) 102104509

(51) Int. Cl. G06F 3/03

(52) U.S. Cl. CPC G06F 3/0304
USPC 345/166

(57) ABSTRACT

An optical navigation system and an optical navigation apparatus thereof are provided. The optical navigation system comprises a host and the optical navigation apparatus. The host detects a running program to generate a control signal. The optical navigation apparatus, which is connected to the host in a wireless way, receives the control signal and performs a performance configuration according to the control signal to adjust an image data amount that is required for processing.

### CROSS-REFERENCES TO RELATED APPLICATIONS

The present invention claims priority under 35 U.S.C. §119 to Taiwan Application No. 102104509 filed Feb. 6, 2013, the entire content of which is incorporated herein by reference.

### BACKGROUND OF THE INVENTION

1. Field of the Invention

The present invention relates to an optical navigation system and an optical navigation apparatus thereof. More particularly, the optical navigation apparatus of the present invention adjusts an image data amount that is required for processing according to a control signal received from a host, wherein the control signal is generated by the host detecting a running program.

2. Descriptions of the Related Art

With the widespread use of personal computers (PCs), various kinds of optical navigation apparatuses (e.g., mice and tracking balls) have been widely used to operate cursors in operating systems. Because some applications in operating systems require a high performance during the operation of a cursor, optical navigation apparatuses of different specifications have been available in the market.

For example, some optical navigation apparatuses retrieve images at a high frame rate or process images at a high precision. However, such optical navigation apparatuses with high frame rates or high precision consume power. Consequently, batteries of such optical navigation apparatuses need to be replaced or recharged frequently, which causes inconvenience and leads to an increased total cost due to the replacement of the batteries.

Accordingly, it is important to reduce the power consumption of such optical navigation apparatuses with a high frame rate or high precision.

### SUMMARY OF THE INVENTION

An objective of the present invention is to provide an optical navigation system, which comprises a host and an optical navigation apparatus connected to the host in a wireless way. The host is configured to detect a running program to generate a control signal. The optical navigation apparatus is configured to receive the control signal and perform a performance configuration according to the control signal to adjust an image data amount of an image data required to be processed. The image data is generated by the optical navigation apparatus based on images captured by the optical navigation apparatus when the optical navigation apparatus relatively moves across a working surface.

Another objective of the present invention is to provide an optical navigation apparatus, which comprises a transceiver, an image capture module and a processor electrically connected to the transceiver and the image capture module. The transceiver receives a control signal from a host in a wireless way. The control signal is generated by the host detecting a running program. The image capture module, being configured to capture the images to generate an image data when the optical navigation apparatus relatively moves across a working surface. The processor performs a performance configuration according to the control signal to adjust an image data amount of the image data required to be processed.

Accordingly, the optical navigation system of the present invention generates corresponding control signals by detecting various programs that are run by the host, and has the optical navigation apparatus perform the performance configuration according to the control signals so that the image data amount that is required for processing is adjusted to a suitable level. Although the optical navigation apparatus of the present invention has a high frame rate and high precision, the power consumption can be reduced since different frame rates or precisions can be set according to different programs that are run by the host. Thereby, the frequency and costs of replacing or recharging the battery are reduced.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an optical navigation system according to the first embodiment of the present invention;

FIG. 2 is a schematic view of an optical navigation apparatus according to the first, second and third embodiments of the present invention;

FIG. 3 is a schematic view of an optical navigation apparatus according to the fourth embodiment and a third embodiment of the present invention;

FIG. 4 is a schematic view of an optical navigation apparatus according to the fifth embodiment of the present invention;

FIG. 5 is a schematic view of an optical navigation apparatus according to the sixth embodiment of the present invention; and

### DESCRIPTION OF THE PREFERRED EMBODIMENT

It shall be appreciated that the following embodiments are only intended to illustrate the technical contents of the present invention, but not to limit the scope of the present invention. In the following embodiments and attached drawings, elements unrelated to the present invention are omitted from depiction; and dimensional relationships among the individual elements in the attached drawings are illustrated only for the ease of understanding, but not to limit the actual scale.

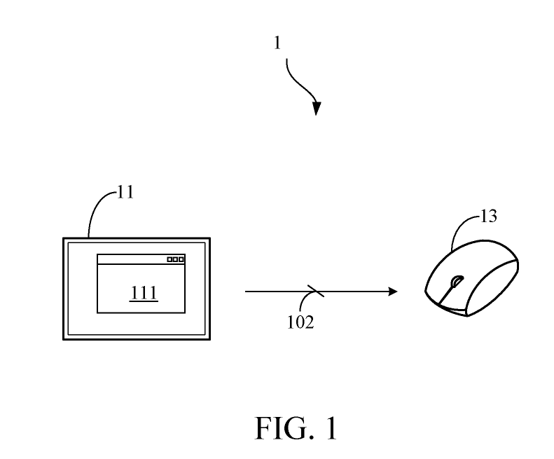

The first embodiment of the present invention is shown in FIG. 1, which is a schematic view of an optical navigation system 1 of the present invention. The optical navigation system 1 comprises a host 11 and an optical navigation apparatus 13. The host 11 is connected to the optical navigation apparatus 13 in a wireless way.

The host 11 detects a running program 111 to generate a control signal 102. In particular, the host 11 executes an operating system (e.g., Microsoft windows or Linux) in which an application associated with the optical navigation apparatus is installed. Through the use of this application, the host 11 can detect the running program 111 (e.g., word processing software, drawing software and game software) that is currently run by the operating system. In other words, the host 11 detects the running program 111 that is being operated by a user through the use of the application in the optical navigation apparatus.

In addition to detecting the running program 111, the application of the host 11 is further configured to determine the performance that the running program 111 requires for operating the cursor to generate a corresponding control signal 102. After receiving the control signal 102 from the host, the optical navigation apparatus 13 performs a performance configuration according to the control signal 12 to adjust an image data amount of an image data that is required for processing. Specifically, the image data is generated by the optical navigation apparatus based on images captured by the optical navigation apparatus when the optical navigation apparatus relatively moves across a working surface.

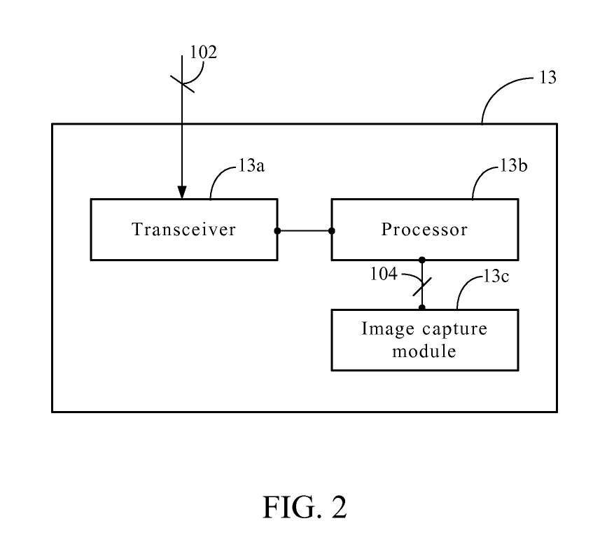

Furthermore, FIG. 2 is a schematic view of the optical navigation apparatus 13 of the present invention. The optical navigation apparatus 13 comprises a transceiver 13a, a processor 13b and an image capture module 13c. The transceiver 13a is electrically connected to the processor 13b and receives the control signal 102 in a wireless way. The image capture module 13c is electrically connected to the processor 13b. The image capture module 13c captures images of a working surface, especially when the optical navigation apparatus relatively moves across the working surface, generates an images data 104, and transmits the image data 104 to the processor 13b. The processor 13b performs the performance configuration according to the control signal 102 to adjust the image data amount of the image data 104 that is required for processing.

The second embodiment of the present invention is also as shown in FIG. 2. In this embodiment, the performance configuration is performed to set a frame rate for an image capture of the image capture module 13c. In particular, when the running program 111 requires a high performance to operate the cursor, the control signal 102 transmitted by the host 11 will be a high performance signal. Therefore, the optical navigation apparatus 13 sets the frame rate (frames per second; fps) to a high performance value according to the high performance signal so that the image data amount that is required for processing is increased. In other words, when the processor 13b of the optical navigation apparatus 13 determines that the control signal 102 is a high performance signal, the processor 13b sets the frame rate of the image capture module 13c to the high performance value so that the image data amount that is required for processing by the processor 13b itself is increased. An example of a high performance value of the frame rate is 9000 fps.

Furthermore, when the running program 111 requires a normal performance to operate the cursor, the control signal 102 transmitted by the host 11 will be a normal performance signal. Therefore, the optical navigation apparatus 13 sets the frame rate to a default value according to the normal performance signal. In other words, when the processor 13b of the optical navigation apparatus 13 determines that the control signal 102 is a normal performance signal, the processor 13b sets the frame rate of the image capture module 13c to the default value so that the image data amount that is required for processing by the processor 13b itself is adjusted to a normal state. For example, the default value of the frame rate is 3000 fps.

Furthermore, when the running program 111 requires a low performance to operate the cursor, the control signal 102 transmitted by the host 11 will be a low performance signal. Therefore, the optical navigation apparatus 13 sets the frame rate to a power saving value according to the low performance signal so that the image data amount that is required for processing is decreased. In other words, when the processor 13b of the optical navigation apparatus 13 determines that the control signal 102 is a low performance signal, the processor 13b sets the frame rate of the image capture module 13c to the power saving value so that the image data amount that is required for processing by the processor 13b itself is decreased. For example, the power saving value of the frame rate is 1500 fps.

The third embodiment of the present invention is also as shown in FIG. 2. As compared to the second embodiment, the performance configuration of this embodiment is to set a precision of image processing (i.e., the number of pixels required to be processed in the image data 104) of the processor 13b. In particular, when the control signal 102 is a high performance signal, the optical navigation apparatus 13 sets the precision of image processing of the processor 13b to a high performance value according to the high performance signal so that the image data amount required to be processed by the processor 13b itself is increased. For example, the high performance value of the precision is 100×100 pixels.

Furthermore, when the control signal 102 is a normal performance signal, the optical navigation apparatus 13 sets the precision of image processing of the processor 13b to a default value according to the normal performance signal so that the image data amount that is required for processing by the processor 13b itself is adjusted to a normal state. For example, the default value of the precision is 50×50 pixels. Furthermore, when the control signal 102 is a low performance signal, the optical navigation apparatus 13 sets the precision of image processing of the processor 13b to a power saving value according to the low performance signal so that the image data amount that is required for processing by the processor 13b itself is decreased. For example, the power saving value of the precision is 25×25 pixels.

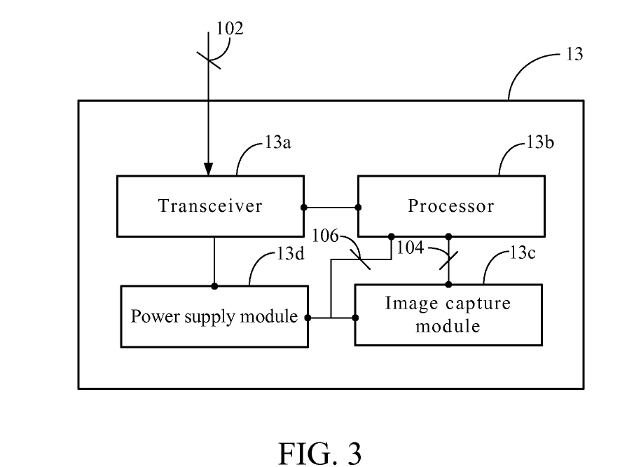

The fourth embodiment of the present invention is shown in FIG. 3. As compared to the first, second and third embodiments, the optical navigation apparatus 13 of this embodiment further comprises a power supply module 13d, which is electrically connected to the transceiver 13a, processor 13b and image capture module 13c. The power supply module 13d detects an output voltage of a battery and generates a trigger signal 106 to the processor 13b when the output voltage is lower than the threshold value. The processor 13b then performs the performance configuration according to the trigger signal 106 to decrease the image data amount that is required for processing, thereby achieving the power saving effect.

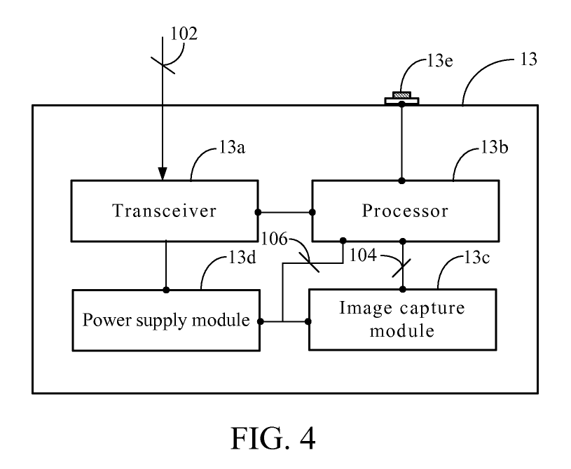

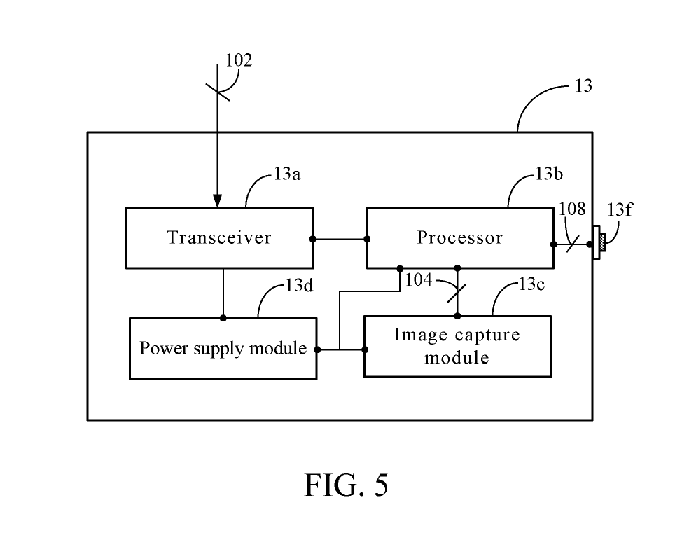

The fifth embodiment of the present invention is shown in FIG. 4. As compared to the fourth embodiment, the optical navigation apparatus 13 of this embodiment further comprises one or more function keys 13e (i.e., programmable shortcut keys) which are electrically connected to the processor 13b. For the purpose of simplicity, only one function key 13e is depicted in FIG. 5. However, ordinary people skilled in the art can readily appreciate the operational relationships between multiple function keys 13e and the processor 13b upon reviewing the description of this embodiment. As previously described, when the detected output voltage of the battery is lower than the threshold value, the power supply module 13d generates the trigger signal 106 to the processor 13b. Therefore, to enhance the power saving effect, the processor 13b further disables the function key 13e according to the trigger signal 106 in this embodiment to reduce the power consumption attributed to the operation of the function key 13e.

The sixth embodiment of the present invention is shown in FIG. 5. As compared to the second and third embodiments, the optical navigation apparatus 13 in this embodiment further comprises a control key 13f electrically connected to the processor 13b. A trigger signal 108 is generated by the control key 13f when the user depresses the control key 13f. Then, the processor 13b further performs the performance configuration according to the trigger signal 108 generated by the control key 13f so that the image data amount required to be processed by the processor 13b is adjusted.

The control key 13f can be designed to be switched among the high performance value, default value and power saving value each time it is depressed, but it is not limited thereto. Accordingly, in addition to triggering the optical navigation apparatus 13 to perform the performance configuration by having the host 11 automatically detect the running program 111 that the current operating system mainly runs, the present invention can further allow the user to duly and manually trigger the optical navigation apparatus 13 to perform the performance configuration by using the control key 13f.

According to the above descriptions, the present invention provides an optical navigation system in which a host detects a main running program and determines the requirement thereof for operating a cursor so that an optical navigation apparatus can perform a performance configuration. Accordingly, when the running program requires a low performance to operate the cursor, the host can transmit a control signal that enables the optical navigation apparatus to decrease the image data amount that is required for processing, thereby saving power.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical navigation system, comprising:
a host, being configured to detect a running program to generate a control signal; and
an optical navigation apparatus, connected to the host in a wireless way, being configured to receive the control signal and perform a performance configuration according to the control signal to adjust an image data amount of an image data required to be processed,
wherein the image data is generated by the optical navigation apparatus based on images captured by the optical navigation apparatus when the optical navigation apparatus relatively moves across a working surface.

2. The optical navigation system as claimed in claim 1, wherein the optical navigation apparatus comprises an image capture module configured to capture the images, and the performance configuration is performed to set a frame rate for an image capture of the image capture module.

3. The optical navigation system as claimed in claim 2, wherein the control signal is a high performance signal and the optical navigation apparatus sets the frame rate to a high performance value according to the high performance signal to increase the image data amount.

4. The optical navigation system as claimed in claim 2, wherein the control signal is a low performance signal and the optical navigation apparatus sets the frame rate to a power saving value according to the low performance signal to decrease the image data amount.

5. The optical navigation system as claimed in claim 2, wherein the control signal is a normal performance signal and the optical navigation apparatus sets the frame rate to a default value according to the normal performance signal.

6. The optical navigation system as claimed in claim 1, wherein the optical navigation apparatus comprises an image capture module and a processor, the image capture module is configured to capture the images and is electrically connected to the processor, and the performance configuration is performed to set a precision of an image processing of the processor.

7. The optical navigation system as claimed in claim 6, wherein the control signal is a high performance signal and the optical navigation apparatus sets the precision to a high performance value according to the high performance signal to increase the image data amount.

8. The optical navigation system as claimed in claim 6, wherein the control signal is a low performance signal and the optical navigation apparatus sets the precision to a power saving value according to the low performance signal to decrease the image data amount.

9. The optical navigation system as claimed in claim 6, wherein the control signal is a normal performance signal and the optical navigation apparatus sets the precision to a default value according to the normal performance signal.

10. The optical navigation system of claim 1, wherein the optical navigation apparatus further receives an output voltage from a battery, detects the output voltage, and performs the performance configuration when the output voltage is lower than a threshold value to decrease the image data amount.

11. The optical navigation system as claimed in claim 10, wherein the optical navigation apparatus further disables at least one function key of the optical navigation apparatus when the output voltage is lower than the threshold value.

12. The optical navigation system as claimed in claim 1, wherein the optical navigation apparatus comprises a control key, and performs the performance configuration to adjust the image data amount according to a trigger signal generated by the control key .

13. An optical navigation apparatus, comprising:
a transceiver, being configured to receive a control signal from a host in a wireless way, the control signal being generated by the host detecting a running program;
an image capture module, being configured to capture images to generate an image data when the optical navigation apparatus relatively moves across a working surface; and
a processor electrically connected to the transceiver and the image capture module, being configured to perform a performance configuration according to the control signal to adjust an image data amount of the image data required to be processed.

14. The optical navigation apparatus as claimed in claim 13, wherein the performance configuration is performed to set a frame rate for an image capture of the image capture module.

15. The optical navigation apparatus as claimed in claim 14, wherein the control signal is a high performance signal and the processor sets the frame rate to a high performance value according to the high performance signal to increase the image data amount.

16. The optical navigation apparatus as claimed in claim 14, wherein the control signal is a low performance signal and the processor sets the frame rate to a power saving value according to the low performance signal to decrease the image data amount.

17. The optical navigation apparatus as claimed in claim 14, wherein the control signal is a normal performance signal and the optical navigation apparatus sets the frame rate to a default value according to the normal performance signal.

18. The optical navigation apparatus as claimed in claim 13, wherein the performance configuration is performed to set a precision of an image processing of the processor.

19. The optical navigation apparatus as claimed in claim 18, wherein the control signal is a high performance signal and the processor sets the precision to a high performance value according to the high performance signal to increase the image data amount.

20. The optical navigation apparatus as claimed in claim 18, wherein the control signal is a low performance signal and the processor sets the precision to a power saving value according to the low performance signal to decrease the image data amount.

21. The optical navigation apparatus as claimed in claim 18, wherein the control signal is a normal performance signal and the processor sets the precision to a default value according to the normal performance signal.

22. The optical navigation apparatus as claimed in claim 13, further comprising a power supply module, wherein the power supply module connects to the processor and receives an output voltage of a battery, the power supply module detects the output voltage of the battery and generates a trigger signal when the output voltage is lower than a threshold value, and the processor further performs the performance configuration according to the trigger signal to decrease the image data amount.

23. The optical navigation apparatus as claimed in claim 22, further comprising at least one function key electrically connected to the processor, wherein the processor further disables the at least one function key according to the trigger signal.

24. The optical navigation apparatus as claimed in claim 13, further comprising a control key electrically connected to the processor, and the processor further performs the performance configuration to adjust the image data amount according to a trigger signal generated by the control key.
